(19) United States
(12) Patent Application Publication
(10) Pub. No.: US 2008/0088836 A1
(43) Pub. Date: Apr. 17, 2008

(54) APPARATUS FOR DETERMINING A PHYSICAL QUANTITY

(75) Inventors: Helmuth Senn, Graz (AT); Klaus Ritzmann, Graz (AT); Wolfgang Belitsch, Graz (AT)

Correspondence Address: Henry M. Feiereisen;Henry M Feiereisen, LLC, Suite 4714, 350 Fifth Avenue, New York, NY, 10118, US

(73) Assignee: Labor fur MESSTECHNIK DR. HANS STABINGER GmbH, Graz (AT)

(21) Appl. No.: 11/871,378

(22) Filed: Oct. 12, 2007

(30) Foreign Application Priority Data
Oct. 12, 2006 (AU) A 1698/2006

(51) Int. Cl. G02B 27/32

(52) U.S. Cl. 356/256

(57) ABSTRACT

A device for determining a physical quantity of a sample, in particular for determining the density of a fluid, is implemented as an optical measuring device which allows an evaluation the reliability of the measured value in the measurement of the physical quantity of the sample.

### CROSS-REFERENCES TO RELATED APPLICATIONS

This application claims the priority of Austrian Patent Application, Serial No. A 1698/2006, filed Oct. 12, 2006, pursuant to 35 U.S.C. 119(a)-(d), the content of which is incorporated herein by reference in its entirety as if fully set forth herein.

### BACKGROUND OF THE INVENTION

The present invention relates to an apparatus for determining a physical quantity of a sample.

Nothing in the following discussion of the state of the art is to be construed as an admission of prior art.

An apparatus for determining the density of fluids according to the oscillator principle in compliance with ISO 15212-1:1998 is known to include a density sensor which can be readily filled with the sample or which is immersed in the sample, a device for exciting and monitoring the oscillation of the density sensor, a device for determining and displaying the density, the oscillation frequency or period, a device for determining and displaying the sample temperature, for which the density measurement is valid, and a system for determining and displaying performance and operation errors. In addition, the apparatus may include additional devices for controlling the temperature of the sample and the density sensor, devices for supplying the sample, and devices for cleaning the density sensor. The aforementioned devices can be integrated in the device for determining the density of fluids or can be implemented as separate components.

The attainable measurement accuracy in determining a physical quantity of a sample with the afore-described apparatus depends substantially of the manufacture of the sample, the sample preparation and the sample itself. Accordingly, a finished prepared sample should be examined before and after the measurement by the operator of the device to determine the quality of the sample. Determining the quality is frequently quite difficult and the quality of the measurement often depends on an estimate from the tester. When measuring the density according to the flexural oscillator principle according to EN ISO 15212 or ASTM D 4052, the accuracy of the measurement depends significantly on the homogeneity of the sample fluid, if the sample is inserted into the test tube without air bubbles, and if the test tube is free of residues before being filled.

Ideally, all steps from sample preparation to sample evaluation would be controlled by a single entity, so that the sample is uniformly cared for. However, this is generally not the case when a physical quantity of a sample is determined in an industrial or heavy-industry setting. Frequently, several people are responsible for manufacturing the sample and likewise, several operators are responsible for operating the measurement device. This has the disadvantage that the control and therefore also the evaluation of the sample quality depends on the subjective observation by the observer or the operator of the device.

It would therefore be desirable and advantageous to address these problems and to obviate other prior art shortcomings.

### SUMMARY OF THE INVENTION

According to one aspect of the present invention, an apparatus for determining a physical quantity of a sample, in particular for determining the density of a fluid, includes an optical measuring device for determining a quality of a sample.

With this approach, the impact of the subjective observation of an observer can be reduced, because the optical measuring device facilitates a determination of the quality of the sample for the observer, the influence of the subjective observation by an observer is reduced, so that different people will judge the quality of the sample as being the same. Determining the sample quality under uniform criteria makes it possible to evaluate the potential measurement accuracy of the measured value for that sample. A confidence range or a standard deviation can be associated with each measured value of the sample depending on the quality of the sample. Using the optical measuring device simplifies personnel training and allows marginally trained personnel to make a qualified assessment of the sample quality or of the measurement accuracy that can be attained with this sample quality. In this context, “determining the quality of the sample” is to be understood as comparing the sample to be evaluated with a standard sample and/or a standard value of a sample. More generally, a quality value can be determined as defined in EN ISO 9000:2005: quality is the degree, with which a set of inherent characteristics satisfies certain requirements. Or based on IEC 2371, quality is the agreement between the determined properties and the previously defined requirements of an observation unit. Industrial and heavy-industry facilities according to the afore-described exemplary embodiment are known to have measurement systems with automatic fill, automatic measurement and automatic cleaning devices. With the optical measuring device, the quality of the sample can advantageously be determined automatically, because the device can be easily integrated into an automated process flow.

According to a particularly advantageous embodiment, the optical measuring device can be configured for detecting inhomogeneities, such as air inclusions or contaminants. The term “inhomogeneity”, also referred to as “heterogeneity”, is meant to indicate the non-uniformity of the sample with respect to one or several characteristic features. An optical measuring device for detecting inhomogeneities has thus the advantage that homogeneous samples can be differentiated from inhomogeneous samples and that samples not corresponding to a nominal state can be marked accordingly. More particularly, samples which are well-suited for a measurement can be differentiated from samples that are less suited for a measurement by detecting air inclusions or contaminants, and depending on their suitability, a confidence range or a standard deviation can be associated with the measured value of these samples.

According to another feature of the present invention, the optical measuring device can be configured for detecting deviating, in particular homogeneously distributed, optical properties, for example brightness, color, contrast or turbidity. The sample intended for a measurement can thereby be compared with the standard condition for the sample and/or with a standard sample, and deviating optical properties can be determined even when these are homogeneously distributed. This makes it possible, for example, to identify wrong sample components or wrong samples which differ in their optical properties from the standard condition of the sample and/or from a standard sample. Depending on the difference and the size of the difference, a confidence range or a standard deviation can be assigned to the measured value for these samples.

According to another feature of the present invention, the optical measuring device may include at least one brightness sensor. This detector for measuring the brightness converts the brightness into an electric signal which can thereafter be easily processed, and enables with a suitable configuration of the sample, to thereafter at least partially process the measured brightness signal automatically. An embodiment with such sensor can be manufactured quite inexpensively, and only small quantities of signal data need to be processed electronically.

According to another feature of the present invention, the optical measuring device may include at least one color sensor. This detector for determining color converts the measured color into an electrical signal which can be readily processed further electronically, in particular by electronic data processing. With a suitable design of the sensor, the color signal can be at least partially further processed automatically. An embodiment with such sensor can be manufactured quite inexpensively, and only small quantities of signal data need to be processed electronically.

According to another feature of the present invention, the optical measuring device may include a camera, which has the advantage that the camera acquires an image which shows the quality of the sample in detail. Determining the quality of the sample, i.e., a determination, if the sample is suitable for the measurement, can be carried out very reliably. The camera may be analog or digital and may therefore produce a material image or digitized image data. The material images or image data produced by the camera can be archived, so that the quality of the sample can be assessed at a later date and unambiguously associated with the sample and the corresponding measurement, thereby producing a documentation of the images. With measurements of long duration, in particular during measurements at night, the camera can automatically capture an image of the sample in regular intervals and store the data. The measurement data can then be recorded in their entirety and documented even without the presence of an observer.

In this context, the camera may include an image sensor, in particular a CCD or CMOS sensor. With a CCD or CMOS sensor, the analog optical image can be converted into an electronic data stream which can be readily processed, in particular into image data that can be visualized using conventional image visualization programs, and the data stream can be stored for documentation or later analysis.

According to another feature of the present invention, the apparatus may include a transparent test tube in which the sample can be arranged, in particular filled. This may enable measurements on powder samples, on liquid samples or sample fluids. The transparent test tube can also facilitate filling of sample volume to a predetermined level.

According to another feature of the present invention, the test tube may be substantially U-shaped. With such configuration, a sample can be measured in test devices and measuring devices adapted for such test tubes, as is customary, for example, with the afore-described device when determining the density of fluids according to the oscillator principle according to ISO 15212-1:1998.

According to another feature of the present invention, the optical measuring device can be in visual contact with the transparent test tube. This has the additional advantage that the quality of the sample can be determined contactless and that the optical measuring device can be positioned facing the sample and the transparent test tube.

Moreover, an evaluation device for evaluating the data supplied by the optical measuring device may be provided. The evaluation device operates to convert the measured data at least partially into information, transforms these data into a form that can be easily processed for the observer and/or stored for later processing, in particular for longer tests. In this way, the presence of an observer for acquiring and controlling the quality of the sample is not required during longer measurements, in particular measurements at night. The data and/or the information derived from the data can be stored for documentation purposes.

The evaluation unit can hereby include means for evaluating the brightness distribution in the data provided by the optical measuring device. With an evaluation unit of this type, at least some data are converted into information or these data are prepared so that they can be easily evaluated by the observer. The data can then at least partially be evaluated automatically, for example to select data being well or poorly suited for a measurement, so that only a portion of the data, for example data which are not clearly borderline values, need to be controlled and evaluated by the trained observer.

According to another feature of the present invention, the evaluation unit may include means for comparing the data supplied by the optical measuring device with reference data, in particular of the empty test tube. The observer can then easily determine the sample quality by employing the means for comparing the data supplied by the optical measuring device with reference data. Advantageously, an at least partially automated evaluation by the comparing means can be simplified by comparing the data and reference data, at least partially, in the evaluation unit itself.

For example, an evaluation unit for evaluating an image acquired by the optical measuring device may be provided. Such evaluation unit can be used to at least partially convert images into information or to convert these images into a form that can be readily evaluated by the observer. The data can then at least partially be evaluated automatically, for example to select data being well or poorly suited for a measurement, so that only a portion of the data, for example data which are not clearly borderline values, need to be controlled and evaluated by the trained observer. Moreover, with a suitable design of the evaluation unit, evaluation at a later time is possible, which is particularly advantageous when the test duration is long, and the images or the information derived from the images can be stored for documentation purposes.

The evaluation unit can hereby include means for evaluating the brightness distribution in the data supplied by the optical measuring device. With an evaluation unit of this type, the image acquired from the sample can be suitably prepared so that it can be easily and clearly evaluated by the observer and automatically processed, either partially or in its entirety.

According to another feature of the present invention, the evaluation unit may include means for comparing the image produced by the optical acquisition unit with a reference image, in particular of the empty test tube. The means for comparing the images produced by the optical acquisition unit with the reference image makes it especially easy for the observer to determine the sample quality. Advantageously, the comparing means simplify at least partially an automated image evaluation, in that the evaluation unit itself, at least partially compares the image with a reference image.

According to another feature of the present invention, the evaluation unit may include means for comparing the image information, in particular the brightness, contrast or color, of adjacent pixels. In this way, inhomogeneities can be easily identified, and with a suitable configuration either partially automatic or fully automatic. In particular, air inclusions and/or contaminants can be detected accurately and reliably.

According to another feature of the present invention, an illumination device for illuminating the sample may be provided. A light source, which may be specially designed for this purpose, enables a uniform illumination of the sample and therefore a determination of the quality of the sample under constant illumination conditions of the sample, thereby increasing the accuracy with which the sample quality can be determined even under different ambient lighting conditions.

According to another feature of the present invention, the apparatus can be implemented as a density measuring device operating according to the flexural oscillator principle. This enables a standardized test configuration, a standardized test process and standardized measured values according to ISO 15212-1:1998 or ASTM D 4052-96.

According to another aspect of the present invention, a method for determining a physical quantity of a sample, in particular for determining the density of a fluid, includes the steps of measuring the sample optically to generate image data, and electronically determining from the generated image data a quality of the sample.

This can reduce the subjectivity of an observation by an observer, because the optical measurement of the sample quality can reduce the influence of the subjectivity of an observation by an observer, so that different people can similarly judge the quality of the sample. The sample quality can be determined under constant conditions and the potential measurement accuracy can be evaluated when determining a physical quantity of the sample, and a confidence range or the standard deviation can be associated with each measured value of the sample indicative of the quality of the sample. Optical measurements on the sample simplify personnel training, allowing lesser trained personnel to make a qualified assessment of the sample quality and the measurement accuracy achievable with this sample quality. Industrial and heavy-industry settings include measurement systems with automatic fill, automatic measurement and automatic cleaning units. Optical measurements of the samples advantageously allow the quality of the sample to be determined automatically, because optical measurements can be easily integrated into the process flow.

In this context, inhomogeneities, in particular air inclusions and contaminants, can advantageously be determined. This further enhances the sensitivity and reliability with which the quality of the sample can be determined.

Other optical properties, in particular brightness, color or turbidity, can also be determined. The sensitivity and the reliability of determining the sample quality can here be increased even further, if the sample is not homogeneous. In this way, for example, a wrong sample fluid can be identified.

Moreover, an image of the sample can be acquired and the quality of the sample can be determined electronically from this image. By displaying the quality of the sample in detail in an image, the quality of the sample can be particularly reliably determined. The image which may be available electronically or in digitized form, can be processed electronically, for example with a computer, or stored, whereby the sample quality can be determined partly or fully automatically. The sample can be stored or documented, allowing later conclusions that can be in uniquely associated with the sample quality.

In this context, the quality of the sample can be determined from the brightness distribution of the image. The brightness distribution is frequently a suitable and sufficient means for determining the quality of a sample and the brightness distribution can be easily processed in the sample. Evaluation can be performed by an observer, or partly or completely automatically. In addition, with this method other interfering optical factors can be excluded, whereby these other interfering factors, for example an additional color distribution, could adversely affect the reliability with which the quality of the sample can be determined.

According to another feature of the present invention, the image can be compared with a reference image, in particular an image of the empty test tube. Such method can enable a particularly simple and clear determination of the sample quality and can also be performed by an observer not specially trained for this task. A partial or complete automation of this process is also feasible, wherein an electronic, for example computerized, evaluation system compares an image of the sample with a reference image, whereby differences are automatically determined by the evaluation system or such differences are processed for a subsequent, better identification of differences by the observer. Contamination of the test tube can also be easily identified before the tube is filled through comparison with at reference image of an empty test tube.

According to another feature of the present invention, the image information, in particular brightness or color, of adjacent pixels can be compared, whereby in particular inhomogeneities, for example air inclusions or contaminants, can be easily identified with high accuracy. The comparison of adjacent pixels can be performed by the observer or can be at least partially automated, whereby automation can be performed electronically, in particularly computerized.

According to another feature of the present invention, the sample can be illuminated. Constant illumination conditions are advantageous in particular when determining the sample quality of fluids. With an illumination device capable of illuminating the sample, which can be configured specifically for this purpose, the effects of ambient light on the result, in particular from surrounding lighting devices, can be lessened, thereby increasing the accuracy with which the sample quality can be determined.

According to another feature of the present invention, the density of sample can be measured according to the flexural oscillator principle. This can enable a standardized test configuration, a standardized test process and standardized measured values according to ISO 15212-1:1998 or ASTM D 4052-96.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is an axonometric diagram of a first embodiment of the device of the invention,

FIG. 1a is an axonometric diagram of a second embodiment of the device of the invention,

FIG. 2 is a schematic diagram of a third embodiment of the device of the invention,

FIG. 2a is a schematic diagram of a fourth embodiment of the device of the invention,

FIG. 3 is a schematic diagram of a fourth embodiment of the device of the invention, and

FIG. 3a is a diagram of the field of view of the camera with an arrangement of the camera according to FIG. 3.

### DETAILED DESCRIPTION OF PREFERRED EMBODIMENTS

Throughout all the Figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

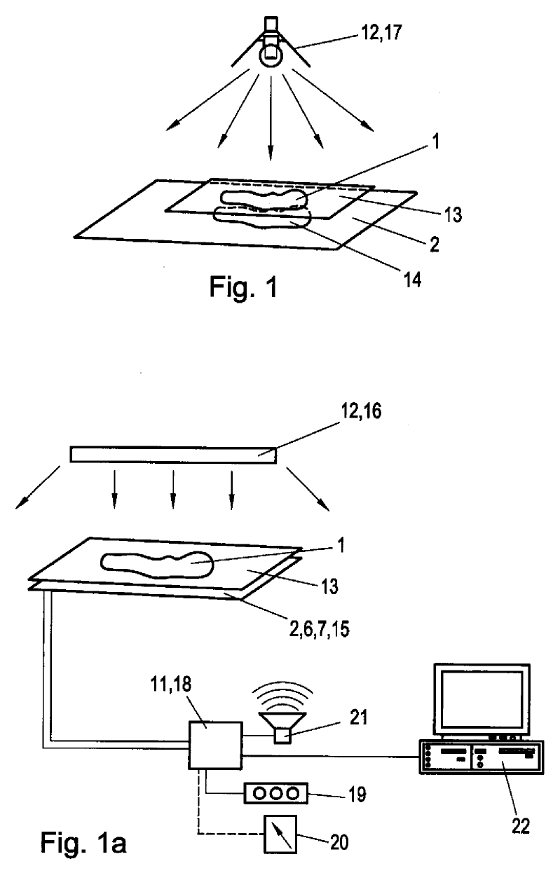

Turning now to the drawing, and in particular to FIGS. 1-3, there are shown embodiments of an apparatus for determining a physical quantity of a sample 1, in particular for determining the density of a fluid, with an optical measuring device 2 for determining the quality of the sample. The effect based on a subjective observation by an observer can be significantly reduced because the optical measuring device 2 enables a determination of the sample quality without subjective influence. At the same time, it becomes significantly easier for different persons to attain a uniform result of the quality test of sample 1. The quality test of sample 1 also allows a conclusion with respect to the reliability of the measured value. With a corresponding design of the optical measuring device 2, personnel less trained for determining the quality of the sample 1 can also make a unchanging statement about the sample quality and the measurement accuracy achieved with this sample quality. Another advantage of the invention can be an at least partial automation of the measurement of the quality of the sample 1. Industrial and heavy-industry facilities according to the afore-described exemplary embodiment include measuring systems with automatic fill units, measurement units and cleaning units. The optical measuring device 2 can advantageously be employed for automatically determining the sample quality, because the device can be readily integrated in an automated process.

FIG. 1 shows a first embodiment of the apparatus according to the invention, having a particularly simple design. The sample 1 is hereby arranged on a sample carrier and can be supplied either in solid form, for example as a thin layer, as a powder, a fluid or a gas. In operation, an optical measuring device 2, which has partially reflecting and partially transparent material, is arranged below the sample carrier 13. For example, this may be a uniform white thin foil made of paper, plastic or the like. In an embodiment according to FIG. 1, an illumination unit 12, for example a spot light 17, may be provided. The spot light 17 which may represent a substantially point-like light source, may cast a shadow 14 of the sample 1 and the sample holder 13 onto the optical measuring device 2 located below. Other illumination units 12, for example neon tubes, projection lamps or even ambient light can be used instead of the spot light. Preferably, the illumination unit 12 should cast a significant shadow 14 of sample 1 and the sample carrier 13 onto the optical measuring device 2.

An observer can evaluate the brightness and/or color of the entire shadow image of the sample 1 and/or the sample carrier 13 from almost any direction. With a suitable design of the illumination unit 12, for example implemented as a projection lamp or a spot light 17, inhomogeneities 3, in particular air inclusions 4 in fluids and/or solids and/or contaminants 5 in the sample 1 and/or the sample carrier 13 can be detected and evaluated. Preferably, a point light source is provided, because the sample 1 and the inhomogeneities 3 can then be visualized on an enlarged scale. This allows an observer who is not specially trained to readily and quickly evaluate, if the quality of the sample 1, respectively the quality of the sample preparation, allows a measurement, or if the probe 1 is less suitable for a measurement.

FIG. 1a shows a second preferred embodiment similar to that of FIG. 1. The sample 1 can here be located on or in the sample carrier 13, and the optical measuring device 2 may be a brightness sensor 6 or a color sensor 7, wherein the sensor 6, 7 can be connected with an evaluation unit 11. In the depicted exemplary embodiment of FIG. 1a, a solar cell 15 is provided as a brightness sensor 6. The light from the illumination unit 12 incident from above, implemented as a neon tube 16, passes through the sample 1 and the sample carrier and is incident on the solar cell 15. The solar cell 15 supplies an electric signal depending on the amount of light passing through the sample 1 and the sample carrier 13. The electric signal is measured with an evaluation unit 11, which may be preferably, as illustrated, implemented as a voltage measurement device 18, and is displayed either visually, with a display, or acoustically. The display can be composed of three LEDs 19 of different color, wherein a green, yellow or red LED indicates the suitability class of the sample for a measurement, or may be an alphanumeric display 20 which displays the voltage or the current of the electric signal. The measurement signal may be indicated acoustically, for example with a loudspeaker configured to produce a sound which can be uniquely associated with the electric signal.

FIG. 1a also shows that the voltage measurement device is directly connected to another evaluation unit 11 for electronic data processing, for example a computer 22. The sample quality can be automatically determined by using suitable evaluation programs. In a preferred embodiment of the invention according to FIG. 1a, the light quantity reflected by the sample 1 and/or the sample carrier 13, instead of the light passing through the sample 1 and the sample carrier, can be measured with a brightness detector 6 or color detector 7, and the obtained electric single can be transmitted to a voltage measurement device 18 or a similar evaluation unit 11.

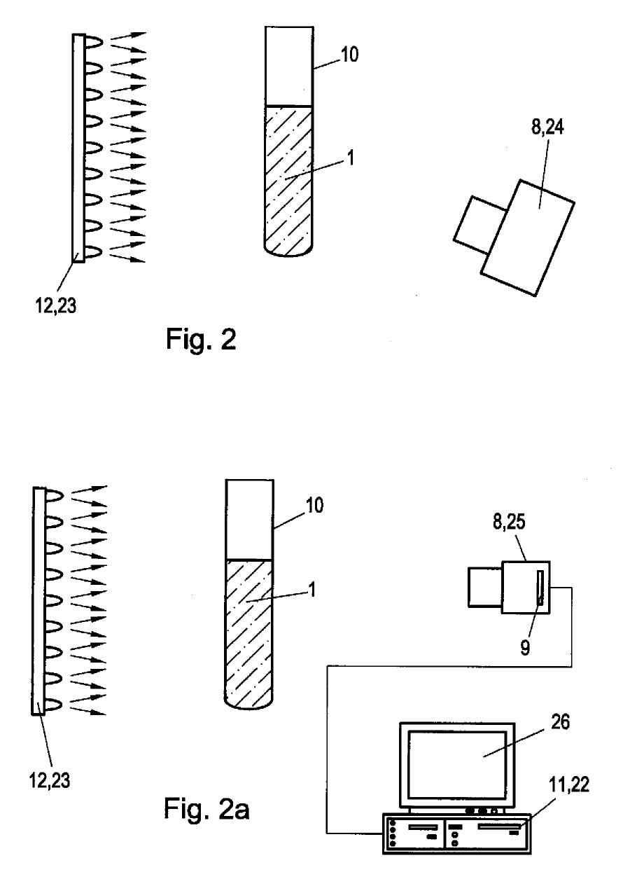

FIG. 2 shows a third embodiment of an apparatus according to the invention, having a transparent test tube 10 and a powder or sample fluid 1 disposed in the test tube 10. the sample can be uniformly illuminated with an illumination unit 12, illustrated in FIG. 2 as an LED array 23, so that the sample 1 is always uniformly illuminated even when the ambient light level changes. A camera 8, for example an instant camera 24, is mounted so as to be in the visual contact with the sample 1, acquiring an image of the sample 1 before each measurement.

The instant camera 24 can be placed so that the sample is located between the illumination unit 12 and the camera 8 or in another position advantageous for acquiring an image of the sample 1. The acquired image shows within several minutes an accurate and detailed representation of the sample 1 and the test tube 10. Both the homogeneity in brightness and color of the sample, as well as any inhomogeneity 3, in particular caused by air inclusions 4 and/or contaminants 5 of the sample 1 or the test tube 10 can then be analyzed and evaluated. An observer can compare the image with a reference image of a sample 1 or an empty test tube 10 and can thereby readily determine if the test preparations are suitable for a measurement or not.

FIG. 2a shows a camera 8 implemented as a digital camera 25 with an image sensor 9, in particular a CCD or CMOS sensor. FIG. 2a also shows the evaluation unit 11, shown in FIG. 2a as a computer, with corresponding imaging and processing software. The digital camera 25 produces image data which can be displayed on a display screen 26 or on the display of the evaluation unit 11 by using suitable image visualization programs and can be evaluated by the observer essentially in real time.

The evaluation unit can also include programs for further processing of the image data. Image details can be enlarged and irregularities, inhomogeneities 3, gas inclusions, in particular air inclusions 4, or contaminants 5 can be displayed on the display screen 26 more clearly. Critical regions of the sample 1 can be detected directly by the program and displayed simultaneously with an overview image on the same screen 26 or on a second screen 26 connected with the computer 22. For easier readability, particularly for personnel not specifically trained for this task, the image can also be reproduced in false colors, altered brightness and/or altered contrast. All this represents partially automated image processing, which can simplify an evaluation of the quality of sample 1 and reduce the subjective effects when evaluating the quality of sample 1.

Additionally, the image information can be further processed by an evaluation unit 11, in particular a computer 22, using a suitable program, thereby promoting automated image processing. The images of sample 1 can be stored and used for documentation. A detector instead of a camera can be used for storing the data of sample 1. The evaluation unit 11 can hereby store the data captured by the optical measuring device level 2, in particular the information generated by the evaluation unit from the data, for later processing or for documentation purposes. If the evaluation unit 11 evaluates the quality of the sample, a confidence range, a standard deviation or a variance can be associated with each measured value, either fully or partially automated. This confidence range can indicate how far the actual measured value of the measured physical quantity of sample 1 deviates from the measured value of the physical quantity of the sample.

In a modification of the invention, a sample 1 which is not suitable for a measurement can be automatically removed from the test apparatus and a new, subsequent sample 1 can be checked automatically for its suitability for a measurement. If the result is positive, the measurement can be started without requiring intervention by the user. An image of the sample 1, the measured value and the confidence range, i.e., there average measurement accuracy achievable with the sample quality, can be stored in the evaluation unit 11 for documentation or future analysis.

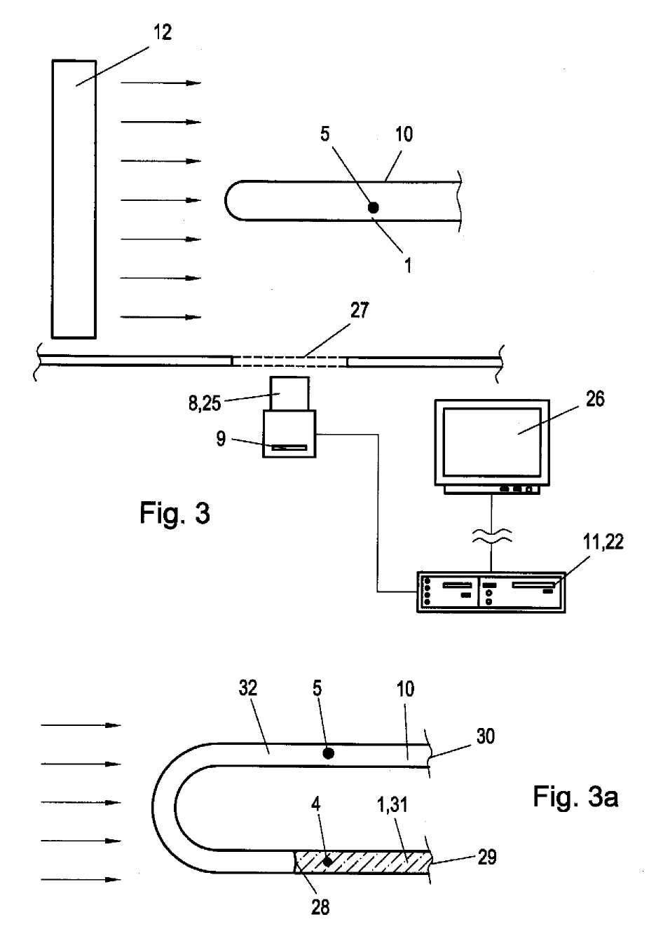

FIG. 3 shows in a top view a fifth preferred embodiment of the invention suitable for density measurements of fluids according to the flexural oscillator principle, in particular according to EN ISO 15212 or ASTM D 4052. In such measurement setup, the accuracy of the measurement depends particularly on introducing the fluid sample 1, i.e., the sample fluid 1, into the U-shaped test tube homogeneously and free of air bubbles. The U-shaped test tube 10 must also be free of residues 5 before being filled. This prerequisite is controlled by applying on the measurement cell a viewing window 27 through which the transparent U-shaped test tube 10 can be observed. FIG. 3 shows a schematic diagram of the U-shaped test tube 10, the illumination unit 12, the camera 8, which can advantageously be implemented as a digital camera 25 with an image sensor 9, and which is placed outside the test cell near or immediately behind the viewing window 27 and is in visual contact with the sample fluid 1, the evaluation unit 11, in particular a computer 22 as well as an associated display, in particular a display screen 26.

FIG. 3a shows an image of the sample fluid 1 and its surroundings acquired with the digital camera 25, which in the embodiment of the apparatus according to FIG. 3 is acquired by the camera 8. The digital camera 25 can capture a single image or several images sequentially. The evaluation unit 11 can process and/or store the images. Storing the images is advantageous for later evaluation and may be used to document the quality of the sample fluid 1.

FIG. 3a shows the U-shaped test tube 10 in the operating position with an inlet 29 for the sample fluid 1 at the bottom and an outlet 30 for the sample fluid 1 at the top. Also shown is a region 31 of test tube 10 filled with a sample fluid 1, the unfilled region 32 of the test tube 10, which contains air or another gas used in the measuring device, as well as a gas inclusion or air inclusion 4 and a contaminant 5 or a residue 5 from an earlier measurement. In the operating position depicted in FIG. 3, the measurement cell located in the test tube 10 is illuminated from the left.

In this arrangement, where the test tube 10, illumination unit 12 and the camera are perpendicular to one another, the boundaries of the gas or air bubbles 4 and the meniscus 28, i.e., the curved boundary surface of the filled 31 and the unfilled region 32 in the test tube 10, produces easily distinguishable light reflexes. A comparison with a reference image of an empty test tube 10 can easily determine if the empty test tube 10 was adequately cleaned. Before the test tube 10 is filled with the sample fluid 1, an image of the empty test tube can be acquired and compared by the evaluation unit 11 or by an observer with an empty test tube 10. In addition, a possible slow formation of a coating in or on the test tube can be detected through comparison with a reference image of the empty test tube 10 acquired at the startup of the apparatus. To account for the long-term drift or aging of the electrical system, an image region which is not impacted by the sample to be measured, is measured to compensate for such drift or aging and is used for comparison with a reference image of this image region. The region to be evaluated by the evaluation unit 11 can also be limited by taking an image of an empty test tube 10, for example as a reference image. This can reduce the amount of data to be processed and eliminates unnecessary or detracting image information.

The area which is limited by the reference image to the region of the test tube 10 can advantageously be checked for discontinuities or inhomogeneities 3. These discontinuities in the control image, FIG. 3a, of sample 1 can indicate a poor fill factor, the presence of gas and air bubbles 4 in the sample 1 or contaminants 5, in particular residues 5 in the test tube 10.

The discontinuities in the control image can preferably be analyzed by conventional methods used for image analysis. In particular, gas and air inclusions 4 can be identified as circular or elliptical objects or discontinuities in the control image. By comparing the individual pixels, in particular by comparing neighboring or directly adjacent pixels, the quality of the sample 1 can be determined both with respect to the homogeneity of the charge, in particular with respect to interfering gas or air inclusions 4, as well as the cleanness of the test tube 10, in particular contaminants and residues.

The evaluation unit can automatically analyze, evaluate or determine the sample quality and display the result of the analysis, evaluation or determination on a display unit. Alternatively, the acquired control image of the sample 1 can be displayed on a display, in particular a display screen 26. The display may be located near the measurement cell or may be located in another room or building.

The evaluation unit 11 can classify the sample quality in various gradations as being more or less suitable for the measurement and can mark the sample accordingly, or can apply the corresponding classifications to the sample image and store the image for documentation. The measured value can also be divided into a different quality classes after the measurement on the sample automatically or according to the ranking of the sample quality. Variances, standard deviations or confidence ranges can be assigned to the quality classes, which clearly indicate to the observer the measured value as well as the range of the measuring uncertainty for each measurement performed on a sample.

Other embodiments of the invention include only a subset of the described features, whereby any combination of features, in particular of the different described embodiments, can be contemplated.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. Apparatus for determining a physical quantity of a sample, in particular for determining the density of a fluid, comprising an optical measuring device for determining a quality of the sample.

2. The apparatus of claim 1, wherein the optical measuring device is configured to detect inhomogeneities caused by air inclusions or contaminants, or a combination thereof.

3. The apparatus of claim 1, wherein the optical measuring device is configured to detect deviations from homogeneously distributed optical properties selected from the group consisting of brightness, color, contrast, and turbidity.

4. The apparatus of claim 1, wherein the optical measuring device comprises at least one sensor selected from the group consisting of brightness sensor, color sensor, and camera.

5. The apparatus of claim 4, wherein the camera comprises a CCD or CMOS image sensor.

6. The apparatus of claim 1, further comprising a transparent test tube containing the sample.

7. The apparatus of claim 8, wherein the test tube has a substantially U-shaped configuration.

8. The apparatus of claim 6, wherein the optical measuring device is in visual contact with the transparent test tube.

9. The apparatus of claim 1, further comprising an evaluation unit for processing an image acquired by the optical measuring device or data supplied by the optical measuring device.

10. The apparatus of claim 9, wherein the evaluation unit comprises a processor for processing a brightness distribution of the image acquired by the optical measuring device or the data supplied by the optical measuring device.

11. The apparatus of claim 9, wherein the evaluation unit comprises a processor for comparing the data supplied by the optical measuring device with reference data, or for comparing the image acquired by the optical measuring device with a reference image.

12. The apparatus of claim 11, wherein the reference data or the reference image are obtained on an empty test tube.

13. The apparatus of claim 9, wherein the evaluation unit comprises a comparator for comparing brightness, contrast or color, or a combination thereof, of adjacent pixels.

14. The apparatus of claim 1, further comprising an illumination unit for illuminating the sample.

15. The apparatus of claim 1, constructed as a density measuring device according to a flexural oscillator principle.

16. A method for determining a physical quantity of a sample, comprising the steps of:
measuring the sample optically to generate image data, and
electronically determining from the generated image data a quality of the sample.

17. The method of claim 16, wherein the sample is a fluid and the physical quantity is a density of the fluid.

18. The method of claim 16, wherein determining the physical quantity includes determining inhomogeneities caused by air inclusions or contaminants, or a combination thereof.

19. The method of claim 16, wherein anomalous optical properties of the sample selected from the group consisting of brightness, color and turbidity are determined.

20. The method of claims 16, wherein an image is acquired of the sample and used to electronically determine the quality of the sample.

21. The method of claim 20, wherein the quality of the sample is determined from the brightness distribution of the image.

22. The method of claim 20, further comprising the step of comparing the image of the sample with a reference image of an empty test tube.

23. The method of claim 20, further comprising the step of comparing brightness or color, or both, of adjacent pixels in the image.

24. The method of claim 16, further comprising the step of illuminating the sample.

25. The method according to claim 16, wherein a density of the sample is measured according to a flexural oscillator principle.
